(19) United States
(12) Patent Application Publication
(10) Pub. No.: US 2025/0131026 A1
(43) Pub. Date: Apr. 24, 2025

(54) ARTIFICIAL INTELLIGENCE-BASED METHOD AND SYSTEM FOR GENERATING AND RECOMMENDING MICROLEARNING CONTENT

(71) Applicant: SAUDI ARABIAN OIL COMPANY, Dhahran (SA)

(72) Inventors: Tammam Alakeel, Sugar Land, TX (US); Hassan Mohammadali AI Matouq, AI Qatif (SA)

(73) Assignee: SAUDI ARABIAN OIL COMPANY, Dhahran (SA)

(21) Appl. No.: 18/489,700

(22) Filed: Oct. 18, 2023

(51) Int. Cl. G06F 16/335; G06F 40/284

(52) U.S. Cl. CPC G06F 16/335; G06F 40/284

(57) ABSTRACT

A method for recommending content resources to individuals in an organization. The method includes obtaining a content repository containing one or more content resources, obtaining a first individual data for a first individual and determining, from the first individual data, a first skillset for the first individual, the first skillset including a first skill, the first skill including a first metric including a first description and first value. The method further includes determining a first score for the first skill based on the first individual data and the first metric, obtaining a content map that associates each skill in the first skillset to at least one content resource of the content repository and recommending a first content resource from the content repository for the first individual based on the first score and the content map.

### BACKGROUND

Developing training programs for employees has been a notable challenge in corporate environments.

Microlearning is a type of training method, in which complex topics are broken down into small pieces of information that meet specific learning outcomes and can be accessed anytime by learners. However, developing microlearning strategies involves challenges that need to be addressed. First, properly identifying knowledge gaps requires a thorough analysis of employees' expertise, interests and performance. Furthermore, creating and homogenizing microlearning content is a time-consuming and labor-intensive process. Finally, proper microlearning content needs to be linked to each individual separately in order to create a personalized training experience. Due to the ever-increasing complexity and volume of available data, it is impractical to perform these tasks manually.

Accordingly, there exists a need for an intelligent, automated system that can efficiently assess employees' knowledge gaps, create microlearning content, and recommend personalized microlearning content to each individual.

### SUMMARY

Embodiments disclosed herein generally relate to a method for recommending content resources to individuals in an organization. The method includes obtaining a content repository containing one or more content resources, obtaining a first individual data for a first individual and determining, from the first individual data, a first skillset for the first individual, the first skillset including a first skill, the first skill including a first metric including a first description and first value. The method further includes determining a first score for the first skill based on the first individual data and the first metric, obtaining a content map that associates each skill in the first skillset to at least one content resource of the content repository and recommending a first content resource from the content repository for the first individual based on the first score and the content map.

Embodiments disclosed herein generally relate to a method for generating a repository of content resources. The method includes obtaining a set of skills, each skill in the set of skills including at least one metric, obtaining a content resource, obtaining metadata for the content resource, segmenting the content resource into one or more segments based on the metadata, mapping each segment to at least one metric included in the set of skills, and updating the content repository of content resources with the segmented content resource and associated mapping.

Embodiments disclosed herein generally relate to a system for recommending content resources to individuals in an organization. The system includes a first computer, configured to access a content repository of content resources containing one or more content resources, receive a first individual data for a first individual, and determine, from the first individual data, a first skillset for the first individual, the first skillset including a first skill, the first skill including a first metric including a first description and first value. The computer is further configured to determine a first score for the first skill based on the first individual data and the first metric, access a content map that associates each skill in the first skillset to at least one content resource of the content repository of content resources, recommend a first content resource from the content repository of content resources for the first individual based on the first score and the content map, receive a second individual data for a second individual, and determine, from the second individual data, a second skillset for the second individual, the second skillset including a first skill, the first skill including a first metric, the first metric including a first description and first value. The computer is further configured to determine a second score for the first skill of the second skillset based on the second individual data and the first metric, determine a similarity metric between the first skillset and the second skillset, and recommend a second content resource from the content repository for the first individual based on the similarity metric.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a high-level overview of some of the main components of the invention and the way they interact with each other, in accordance with one or more embodiments.

FIG. 2 depicts a flow chart of a method for recommending a content resource to an individual, in accordance with one or more embodiments.

FIG. 3 depicts a method for recommending a content resource to an individual, in accordance with one or more embodiments.

FIG. 4 depicts details of a content resource recommendation system, in accordance with one or more embodiments.

FIG. 5 depicts a scoring model, in accordance with one or more embodiments.

FIG. 6 depicts a metric computational model, in accordance with one or more embodiments.

FIG. 7 depicts a table that includes examples of metrics measuring job activities, in accordance with one or more embodiments.

FIG. 8 depicts an example of a clustering model, in accordance with one or more embodiments.

FIG. 9 depicts examples of two recommendation systems, in accordance with one or more embodiments.

FIG. 10 depicts a block diagram with an example of an attendance monitoring system, in accordance with one or more embodiments.

FIG. 11 depicts an example of segmenting a content resource, in accordance with one or more embodiments.

FIG. 12 depicts an example of a content acquisition system, in accordance with one or more embodiments.

FIG. 13 depicts an example of a segmentation model, in accordance with one or more embodiments.

FIG. 14 depicts an example of a linking method, in accordance with one or more embodiments.

FIG. 15 depicts an example of a text similarity model, in accordance with one or more embodiments.

FIG. 16 depicts a block diagram that connects the main components of a content acquisition and recommendation system, in accordance with one or more embodiments.

FIG. 17 depicts an example of capturing individual data, in accordance with one or more embodiments.

FIG. 18 depicts an example diagram of a neural network in accordance with one or more embodiments.

FIG. 19 depicts a block diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “content resource” includes reference to one or more of such content resources.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

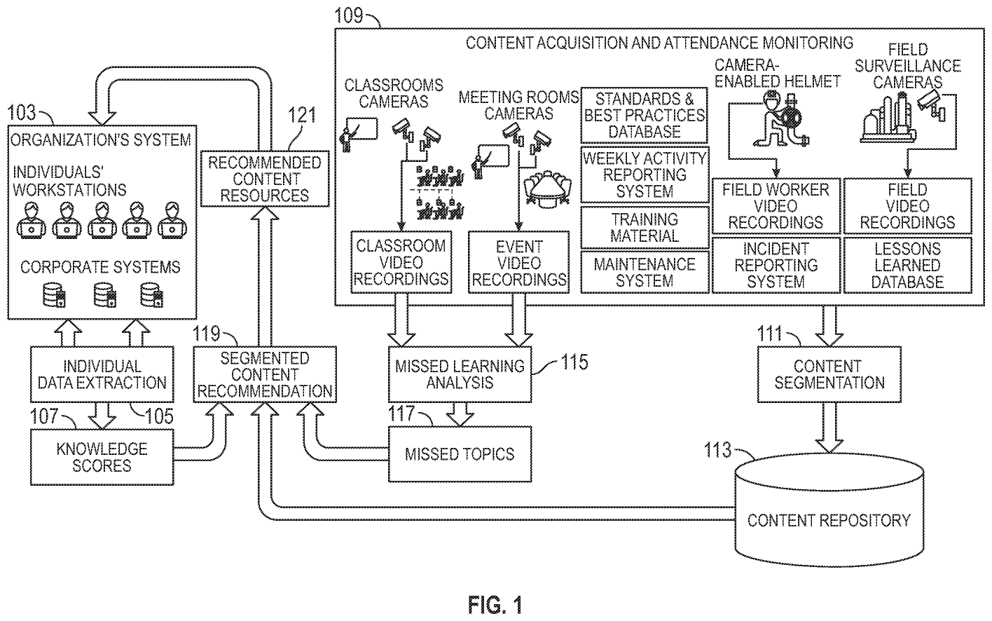

In the following description of FIGS. 1-19, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to a system for automatically developing and deploying a training program, such as a microlearning training program, within an organization. This system includes two separate steps, that are then combined to form a unified training strategy. The first step includes creating learning content material (i.e., “microlearning” resources). The second step includes assessing learning needs for individuals in the organization and recommending learning content accordingly. Combining these two steps, proper learning can be recommended in the second step, from the training material created in the first step.

Throughout this disclosure, the term “microlearning” is replaced with other terms, referring to any material that was extracted from a larger material resource. For instance, the terms “segmented content resource”, or “content resource segment” refer to a microlearning content resource. Furthermore, recommending microlearning content using the methods and system of this disclosure is generalized to recommending any type of training content, that is not necessarily microlearning content. For instance, the terms “content resource recommendation” or “content recommendation” are used, rather than the term “microlearning resource recommendation”.

Training programs within an organization offer various advantages, potentially benefiting the organization's performance, growth, competitiveness, and an increase in its revenue. Training programs help individuals acquire and enhance skills and knowledge necessary to perform their roles effectively, which may lead to improved job performance and increased efficiency. Thus, well-trained employees may offer superior products or services potentially leading to high customer satisfaction and loyalty. Furthermore, continuous training may help individuals adapt to new technologies and market trends and foster a culture of innovation by encouraging employees to think creatively, potentially helping the organization remain competitive. Such skills, for which the individuals are trained, can be of various categories, including technical skills, soft skills, or industry-specific knowledge.

Creating a program may involve several steps. In one or more embodiments, the initial step includes performing a thorough analysis to determine what skills, knowledge, or competencies employees need. As an example, this analysis may be performed by evaluating the individual's performance at a certain task, having the individual take skill tests or fill out questionnaires. Then, specific and measurable learning objectives may be defined to ensure that objectives align with organizational goals and employee development needs. Once training needs and objectives have been identified, learning content may be created, possibly using different methods, leading to different formats. Examples of strategies for creating learning content include observing the content of an organization's database, such as text documents, or videos, detecting which part of this content may provide adequate learning material and segmenting the content accordingly into the different detected parts. Such processes are typically resource intensive, or possibly prohibitive, when performed manually. The methods and systems described in this disclosure aim to perform the learning assessment, learning content creation and recommendation automatically, with the use of artificial intelligence.

To put matters in perspective, FIG. 1 is a high-level overview of some of the main components of the methods and systems described in this disclosure, for illustration purposes. FIG. 1 relates to an organization of individuals. An example of such an organization is a company, and examples of such individuals are employees of that company. The organization has an organization's system (103), that may include, for example, hardware, software, a corporate system, or real estate. Examples of components of such an organization's system (103) include, a computer, an individual workstation, computer operation software, a human resource department, and organization premises, such as an office. Individual data can be extracted from the organization's system (103) as an individual data extraction (105). Examples of individual data that may be extracted through the individual data extraction (105) include an individual's name, date of birth, browsing preferences, and photos of the individual. In one or more embodiments, an individual's job duties themselves can be extracted automatically from the organization's system (103), together with a set of skills that are suitable to perform such duties. Using information contained in an organization's system, knowledge scores (107), that evaluate how important the skills are for the individual's job duties and/or the individual's performance at those skills, can be extracted or computed from the extracted individual data. In one or more embodiments, knowledge scores are computed with artificial intelligence (AI), including scrapping individual data and evaluating the frequency of some key elements, such as key words, in the individual data.

Another component of FIG. 1 is a content acquisition and attendance monitoring system (109), having at least two purposes. A first purpose of the content acquisition and attendance monitoring system (109) includes capturing training or learning content from the organization's activities. Example of training or learning content that may be captured by the content acquisition and attendance monitoring system (109) include a video capture of a class given in a classroom by an instructor, a video of a meeting about the organization's work held in a meeting room, a standards and best practices database, a report about a methodology used to perform a certain work project, and events recorded during field activity performed in a field facility. As such, the content acquisition and attendance monitoring system (109) may include hardware, such as cameras, screens, real estate, storage disks, and software such as an office suite or video transcription software. Acquired training content may be stored in a raw content database. A second purpose of the content acquisition and attendance monitoring system (109) is to monitor individuals' attendance at events, such as training events, possibly using the same cameras or other surveillance tools. In one or more embodiments, some actions of the content acquisition and attendance monitoring system (109) may be automated by using AI.

Generally, a piece of raw training or learning content acquired by the content acquisition and attendance monitoring system (109) is unstructured, includes several topics and useful learning content may alternate sequentially with an unrelated information. For example, the filming of a training event may be started long before the actual start of the event and therefore, the beginning of the resulting video of the training event may not have any learning value. A content segmentation (111) action is used to divide the raw pieces of acquired training content into structured, smaller segments, that may be used for training the individuals of the organization. The segmented content is stored in a content repository (113). In one or more embodiments, the content segmentation (111) makes use of AI.

In one or more embodiments, the material acquired by the content acquisition and attendance monitoring system (109) may also be used to monitor the attendance of the individuals to topics, such as training topics that are taught or discussed during a class. For example, a camera installed in a classroom to film a training event may also be used to monitor an individual's presence in the classroom during a training event. Further examples of monitoring the attendance of an individual at an event are described later in this disclosure. In one or more embodiments, attendance monitoring may be used to determine which part of a training event an individual might have missed, through the missed learning analysis (115) action. Results of the missed learning analysis (115) may include a list of missed topics (117) by individuals.

Finally, based on the knowledge scores (107) at appropriate skills, and the missed topics (117), recommended content resources (121), taken from the content repository (113), are recommended to the individuals of the organization for training, through a segmented content recommendation (119). Details and embodiments of the present invention are discussed in the descriptions of the next figures of this disclosure.

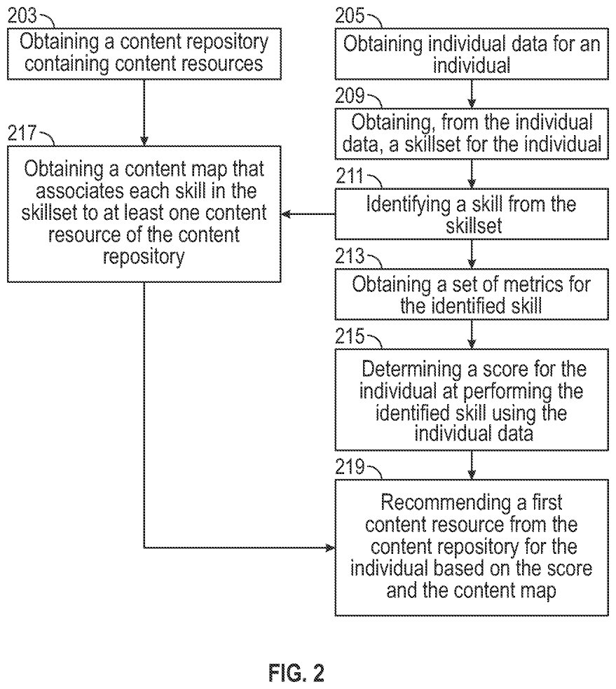

The flow chart in FIG. 2 depicts a method for recommending a content resource to an individual, in accordance with one or more embodiments, the content resource being obtained from a content repository. In Step 203, a content repository is obtained, the content repository including at least one content resource. Examples of content resources included in the content repository include training material for individuals in an organization, such as a written document containing a class, a video of a live class, a lesson learned description, and an accident report which individuals can analyze to prevent such accident from occurring again.

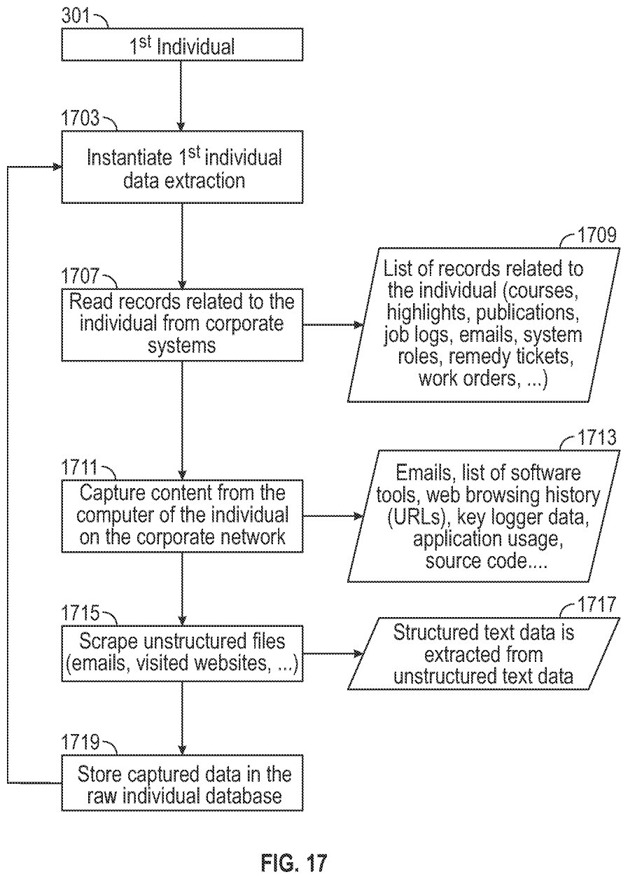

In parallel, but not necessarily simultaneously, to Step 203, individual data are obtained from an individual in Step 205. In one or more embodiments, such individual data is obtained by a system installed on the organization's network, that captures data from computers of individuals in the organization. Examples of such data include an email, software installed on computers in possession of the individuals, a written source code, a web browsing history, an application usage statistic, and a keylogger piece of data. The system may also connect to an organization's database and organization's information systems to gather data about each individual's tasks, such as information about courses that they completed courses, job logs, publications, documents uploaded to a document management system, weekly highlights, resolutions requests sent to an information technology (IT) department, and maintenance work orders. In one or more embodiments, all the data captured, according to the above-listed methods and sources, are stored in a raw content repository. In one or more embodiments, the raw content repository is updated automatically on a regular basis to enable online and continuous assessment, and in turn, the individual data obtained in Step 205 is also regularly or continuously updated. An example of a process to continuously obtaining and updating personal data is described in FIG. 17.

In Step 209, a skillset, including at least one skill, is determined for the individual, from the individual data from Step 205.

In Step 211, a skill is extracted from the skillset obtained in Step 209. In Step 213, a set of metrics, including at least one metric, is obtained corresponding to the skill from Step 211, each metric within the set of metrics describing a measure of a strength of a relationship between the skill from Step 211 and any individual. In one or more embodiments, the skillset from Step 209, all associated skills from Step 211, the metrics from Step 213, and the data needed to calculate the values of the metrics are extracted automatically from the individual data from Step 205, by using a data extraction model. In one or more embodiments, the data extraction model uses artificial intelligence (AI). A score of the individual at the skill from step 211 is obtained in Step 215 from the individual data from Step 205, measuring how strongly the individual relates to the skill from Step 11. In one or more embodiments, Step 215 includes obtaining a value for each metric from the set of metrics from Step 213, from the individual data from Step 205, and the score of the individual at the skill from step 211 is computed as a weighted average of the values of all of the metrics from Step 213. In one or more embodiments, the values of the metrics from Step 213 and the resulting score from Step 215 are determined automatically by a scoring model. In one or more embodiments, the scoring model makes use of AI (e.g., machine learning models and algorithms).

In Step 217, the skill from Step 211 is associated with content resources from the content repository obtained in Step 203 via a content map, which means that the associated content resources from Step 217 are training materials for the first skill from Step 211. Depending on the score obtained in Step 215, the content resources from Step 217, associated with the skill from Step 211, are recommended to the individual in Step 219. In one or more embodiments, the content resource recommendation from Step 219 occurs if the first score from Step 215 is higher than a certain threshold, meaning that the relationship of the individual and the skill from Step 211 is strong. In one or more embodiments, the recommendation in Step 219 is performed automatically by a recommendation system. In some embodiments, the recommendation system uses AI.

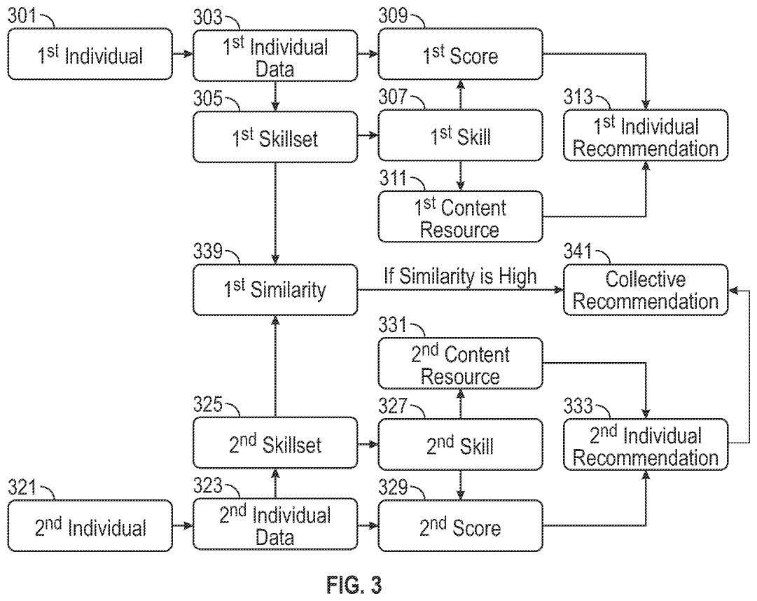

FIG. 3 depicts another type of content resource recommendation to an individual, referenced herein as a collective recommendation, in accordance with one or more embodiments. Initially, a first individual resource recommendation (313) is made to a first individual (301), in a similar fashion as the content resource recommendation is made to an individual in Step 219 in FIG. 2. That is, a first individual data (303), from the organization, is obtained from the first individual (301), as performed in Step 205 in FIG. 2. Then, a first skillset (305) is extracted from the individual data (303), in a similar fashion as Step 209 in FIG. 2. A first skill (307) is extracted from the first skillset (305), to which a first content resource (311) is associated via a map connected to a content repository (113), as performed in Steps 211 and 217 in FIG. 2. A first score (309) is obtained for the first skill (307) from the first individual data (303), and the first content resource (311) is recommended to the first individual (301) as the first individual recommendation (313), similarly to Steps 215 and 219 in FIG. 2.

In general, an organization consists of more than one individual and FIG. 3 shows an example of a second individual (321) that interacts with the first individual (301) in the same organization. In the same way as the first individual recommendation (313) is done for the first individual (301), a second individual data (323) is obtained for the second individual (321), a second skillset (325) is extracted from the second individual data (323), from which a second skill (327) is obtained. A second score (329) for the second skill (327) is computed and a second content resource (331) is recommended to the second individual (321), via a second individual recommendation (333). Then, the second skillset (325) for the second individual (321) is compared with the first skillset (305) for the first individual (301) by determining a first similarity (339). If the first similarity (339) is high, meaning that the second skillset (325) is related to the first skillset (305), the second content resource (331) is also recommended to the first individual (301) via a collective recommendation (341). If the first similarity (339) is low, the second content resource (331) is not recommended to the first individual (301). A mechanism of defining whether the first similarity (339) is high is to compare it with a certain threshold, defining the first similarity (339) as “high” if it is higher than the threshold, and “low” if it is lower than the threshold. In one or more embodiments, the first similarity (339) is computed by using AI, such as a clustering model.

It is noted that FIG. 3 generalizes to an organization that includes any number of individuals, and that a collective recommendation may be made for any number of individuals that may be grouped together as part of the organization. Specifically, content resources recommendations are made individually to a given individual, by extracting individual data specific to that individual, computing a score for a skill that is extracted from individual data and assigning a content resource from a content repository (113), in the same fashion as how the first individual recommendation (313) is made to the first individual (301) and the second individual recommendation (333) is made to the second individual (321). Other recommendations, such as the collective recommendation (341), are then made collectively. In one or more embodiments, individuals are clustered into groups according to similarities between extracted skillsets, in the same ways as the first individual (301) is clustered with the second individual (321) by using the first similarity (339) between the first skillset (305) and the second skillset (325). Then, any content resource recommended to an individual within a group is also recommended to all other individuals in that group. In one or more embodiments, clustering individuals into groups is done by using AI, such as K-means clustering.

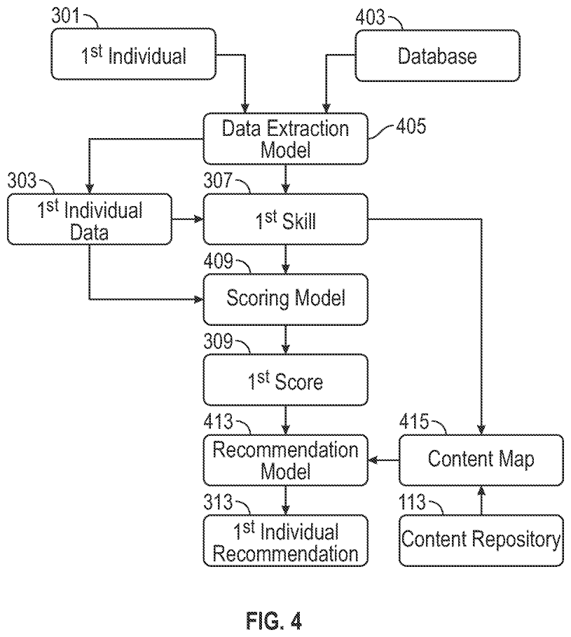

FIG. 4 depicts, in accordance with one or more embodiments, an example of how a first individual recommendation (313) can be made to a first individual (301) using a sequence of different models. Some elements in FIG. 4 were discussed, at least in part, in the description of FIG. 3 and, for simplicity, are not re-explained here. First, using a data extraction model (405), the first individual data (303) for the first individual (301) is extracted from a database (403) that is accessible, and possibly owned by, the organization. Examples of such data include an email, software installed on computers in possession of the individuals, a written source code, a web browsing history, an application usage statistic, and a keylogger piece data. The system may also connect to an organization's database and organization's information systems to gather data about each individual's tasks, such as information about a course that they completed, a job log, a publication, a document uploaded to a document management system, a weekly highlight, a resolutions request sent to an information technology (IT) department, and a maintenance work order. In one or more embodiments, the data extraction model (405) includes AI.

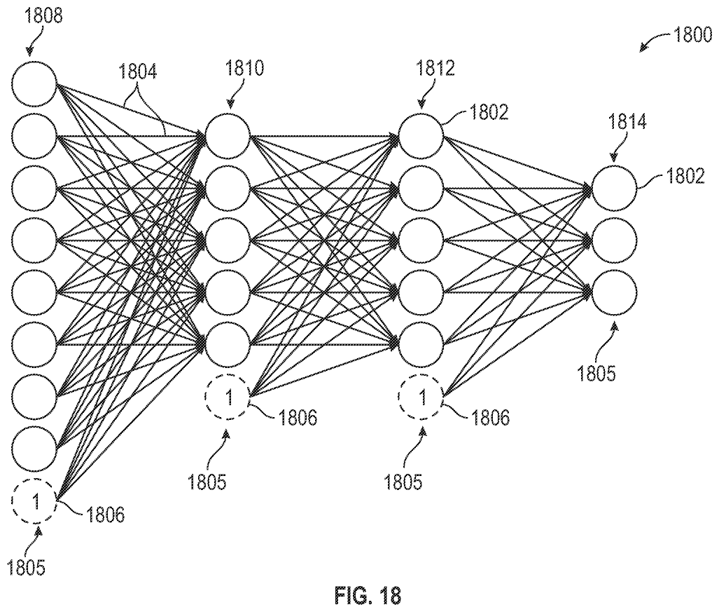

Examples of AI models able to perform such data extraction include natural language processing (NLP) models. NLP models are a type of neural network model designed to understand, interpret, generate, analyze, and process textual data. NLP models can be of various forms, and often include recurrent neural networks (RNN), long-short-term memory (LSTM) models, transformers, fully connected (i.e., dense) networks, or a combination thereof. Herein, artificial intelligence models based on a type of network may generally be referred to as deep learning models or neural networks (NN). Examples of NLP models that may be used for the purpose of the data extraction model (405) include text classification models, that categorize text into predefined categories, and text summarization models, that can automatically summarize long documents into shorter, more interpretable ones. A more complete description of the mechanics of an example of an AI model is given in FIG. 18. The data extraction model (405) further determines, from the extracted first individual data (303), a first skill (307) comprised in a first skillset (305), for the first individual (301).

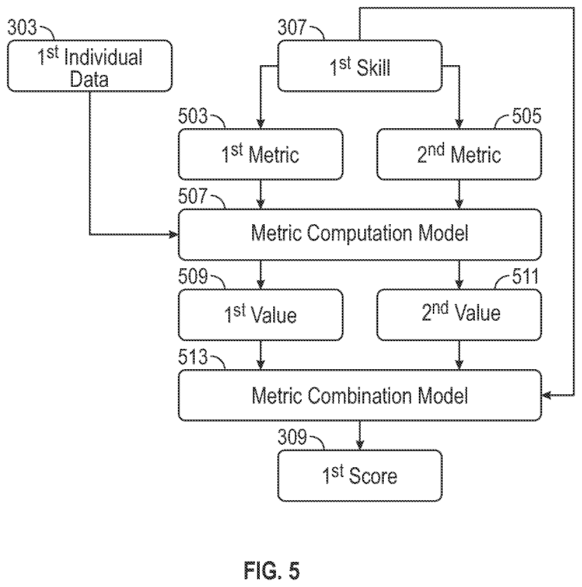

The first skill (307) is assigned a first score (309) through a scoring model (409), the first score (309) representing the level of involvement of the first individual (301) in the first skill (307). While a high first score (309) indicates that involvement of the first individual (301) in the first skill (307) is significant, a low first score (309) indicates that involvement of the first individual (301) in the first skill (307) is not significant. In one or more embodiments, the distinction between a high first score (309) and a low first score (309) is made by using a threshold, in the sense that if the first score (309) is above the threshold, it is considered as high, and if the first score (309) is below the threshold, it is considered as low. In one or more embodiments, the scoring model (409) makes use of AI. In one or more embodiments, the scoring model (409) works by determining metrics for the first skill (307), computing a value for each metric from the first individual data (303) and averaging the values, as described in FIG. 5. Examples of AI models that may be used as the scoring model (409) include, but are not limited to NLP models, non-linear regression models, classification models such as a nearest neighbor model, and clustering models such as a K-means model.

A content map (415) maps content resources within a content repository (113) to the first skill (307), indicating which learning material within the content repository (113) may be used as training material for the first skill (307). Finally, using a recommendation model (413), a content resource from the content repository (113) is recommended to the first individual (301) as a first individual recommendation (313), according to the first score (309) and the content map (415). In one or more embodiments, the recommendation model (413) includes AI. Example of AI models that may be used in the recommendation model (413) include recommender systems and neural networks. Typically, recommender systems are a subclass of information filtering systems that provide personalized recommendations to users. In the example in FIG. 4, a recommender system within the recommendation model (413) may further prioritize content resources according to how significant they are for the first individual (301) according to the first score (309).

FIG. 5 depicts a high-level overview of an example of the scoring model (409). In one or more embodiments, a set of metrics is assigned to the first skill (307). In this specific example, the set of metrics is composed of two metrics: a first metric (503) and a second metric (505). In other examples, the number of metrics included in the set of metrics assigned to the first skill (307) is greater than two. As such, the embodiment described in FIG. 5, that depicts two metrics associated with the first skill (307), should not be construed as imposing a limitation on the instant disclosure.

The first individual data (303), the first metric (503) and the second metric (505) are passed through a metric computation model (507), which assigns a value to each metric, resulting in a first value (509) being assigned to the first metric (503) and a second value (511) being assigned to the second metric (505). The value for a given metric is a measure of how significantly the individual is involved in the first skill (307) according to that metric. The values, including the first value (509) and second value (511) are passed through a metric combination model, that combines the values and outputs the corresponding first score (309). In one or more embodiments, the first skill (307) includes a set of weights, composed of one weight for each metric measuring the first skill (307), each weight representing the importance of that metric in measuring the first skill (307). The weights are also passed through the metric combination model (513) and the first score (309) is computed as a weighted average of the values for the metrics. In the specific example of FIG. 5, the first skill (307) includes a weight for each of the first metric (503) and the second metric (505). The first score (309) is then computed as a weighted average of the first value (509) and the second value (511).

In one or more embodiments, the metric computation model (507) makes use of AI. Examples of AI models that may be used in the metric computation model (507) include NLP models, that fetch text data from individual data and compare that text data with a skill description to infer how significantly an individual is involved in that skill.

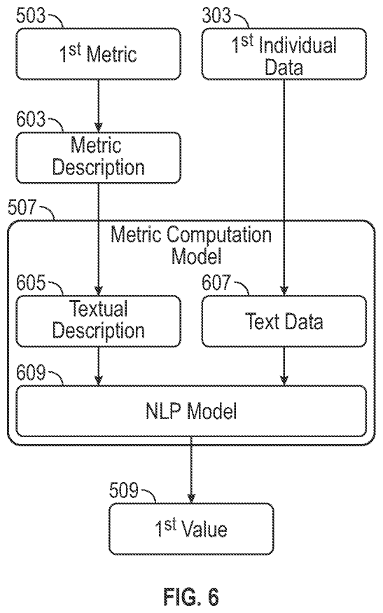

FIG. 6 shows a specific example of a metric computation model (507), that computes the first value (509) for the first metric (503), using a NLP model (609). A metric description (603) is included in, then extracted from the first metric (503). In this example, the metric computation model (507) extracts a textual description (605) from the metric description (603), and text data (607) from the first individual data (303). The textual description (605), describing the first metric (503), and text data (607) are passed through the NLP model (609), that computes the first value (509). In one or more embodiments, the first value (509), computed by the NLP model (609) is derived from a measure of a second similarity between the textual description (605) and the text data (607), such as a cosine similarity. In one or more embodiments, such second similarity is computed by first generating the word embeddings of the textual description (605) and the text data (607), and then calculating the distance between these embeddings. In natural language processing, word embedding involves determining vector representations of words in a continuous vector space, where words with similar meanings are mapped to nearby vectors in this space. Word embedding typically captures semantic relationships and contextual information about words, in the sense that words with a similar meaning or used in similar contexts tend to have a similar word embedding. A notable example of a word embedding algorithm is the Global Vectors for Word Representation (GloVe) algorithm.

In one or more embodiments, the NLP model (609) automatically extracts some key words from the textual description (605) and the second similarity indicates whether these key words also appear in the text data (607), indicating a level of competence of the first individual (301) in accordance with the first metric (503). In some embodiments, the first metric (503) includes a competence at programing computers in a certain coding language, and associated key words are calls to some elements of that coding language. Examples of such key words, when associated with the Python language, include libraries, objects and functions that can be called from the Python language, the libraries including “numpy”, “pandas”, “sklearn”, and “tensorflow”, the objects including “pandas.DataFrame” and “sklearn.cluster.Kmeans”, and the functions including “fit”, “predict” and “compile”. In addition to computing the second similarity, determining the first value (509) by the NLP model (609) may further include computing a frequency of these key words within the textual description (605) and the text data (607). Then, the first value (509) may be based on both the second similarity and the frequency of these key words within the textual description (605) and the text data (607). In one or more embodiments, the NLP model (609) may further include a scrapping algorithm capable of extracting structured textual content from the textual description (605) and the text data (607), which is particularly useful if the textual description (605) or the text data (607) is unstructured. Then, the embedding and second similarity are computed from the scrapped, structured content, rather than the raw textual description (605) and text data (607). Examples of unstructured text data (607) include, but are not limited to, a web browsing history, from which the scraping algorithm extracts an URL as a structured content. In some embodiments, the scraping algorithm is further configured to fetch and scrape data from the web page directed by the URL.

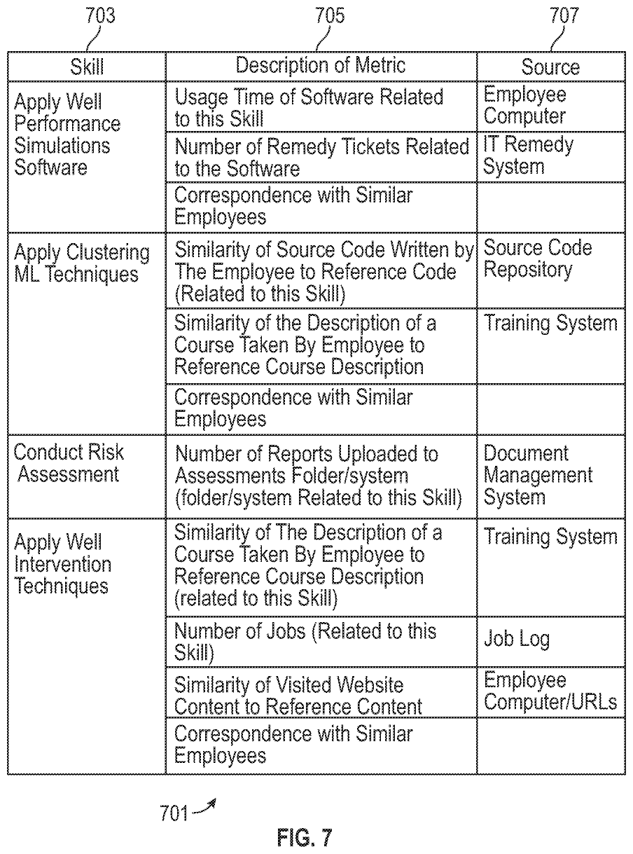

Examples of descriptions for skills and some of their respective metrics are shown in FIG. 7, in accordance with one or more embodiments. Table (701) contains three columns, namely, a first column (703), a second column (705), and a third column (707). The first column (703) contains examples of skills, such as the previously mentioned first skill (307). The second column (705) contains textual definitions of a set of metrics for each skill. It is emphasized that some skills in the first column (703) are associated with multiple metrics. In one or more embodiments, a score for each skill is computed as a weighted average of the values of all metrics for that skill, as depicted in FIG. 5. The third column (707) in Table (701) shows a data source (e.g., contained in the individual data) from which the value of each metric may is determined.

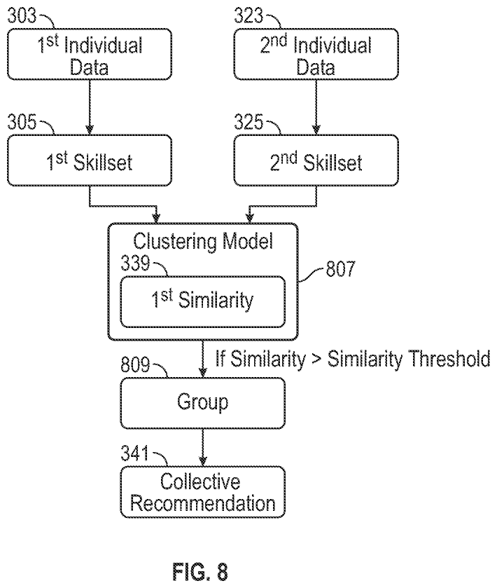

FIG. 8 is a high-level overview of using a clustering model (807) to recommend, to a first individual (301), a content resource that was obtained for other individuals, such as the second individual (321). As mentioned in the description of FIG. 3, a first skillset (305), comprising at least one skill, is extracted from the first individual data (303), and a second skillset (325), comprising at least one skill, is extracted from the second individual data (323). In one or more embodiments, the organization has more than two individuals, from each of which individual data is extracted, resulting in extracting one skillset for each individual. In that regard, FIG. 8 can be extended to organizations of more than two individuals. Clustering is performed by using a clustering model (807), that computes the first similarity (339) between the different skillsets, such as the first skillset (305) and the second skillset (325), and partitions the individuals, such as the first individual (301) and the second individual (321), into different groups, such as group (809), based on the first similarity (339). As such, individuals assigned with similar skillsets are clustered into the same group (809), meaning that their job activities are considered as similar. In one or more embodiments, the first individual (301) and the second individual (321) are clustered into the group (809) if the first similarity (339) is higher than a similarity threshold. Then, any content resource that was recommended to or attended by an individual in a group is recommended, as the collective recommendation (341), to any other individuals in that group that have not yet received that content resource individually. In some embodiments, a content resource is created by an individual in the group, and then recommended to all other individuals in the group. Examples of content resources that may be created by an individual include, but are not limited to, a written or oral presentation, a class about a topic, and a lessons learned report.

In one or more embodiments, the clustering model (807) uses AI. Examples of clustering AI models include K-means, density-based spatial clustering of applications with noise (DBSCAN), and hierarchical clustering. In some situations, clustering algorithms include parameters, that need to be tuned. A notable example is a K-means algorithm, that divides data into K clusters, each of which has a cluster center. A K-Means algorithm is based on minimizing an error, the error being the sum of squared distances between data points and the cluster centers of the cluster to which the data points belong. The number of clusters, K, is a user defined parameter. It is desirable to define an optimum number of clusters, K, as the smallest possible number that partitions the data points meaningfully, according to a given problem that is to be solved by the K-means algorithm. The elbow method is suitable for selecting such optimum number of clusters K. The elbow method consists of running the K-means algorithm a defined number of times, each time with a different, increasing number of clusters K, and plotting the value of the error for each run. As the number of cluster centers increases, the error also decreases. For a certain value of K, denoted as K* and called the elbow point, the decrease of the error between the K*-means algorithm and the (K*+1)-means algorithm becomes small. This value of K, K*, is selected as the final number of clusters, and the corresponding K*-means clustering, using K* cluster centers, is considered final. Other methods for determining the optimal number of clusters, or more generally tuning any parameters associated with the clustering model, such as the silhouette method, may be employed without departing from the scope of this disclosure.

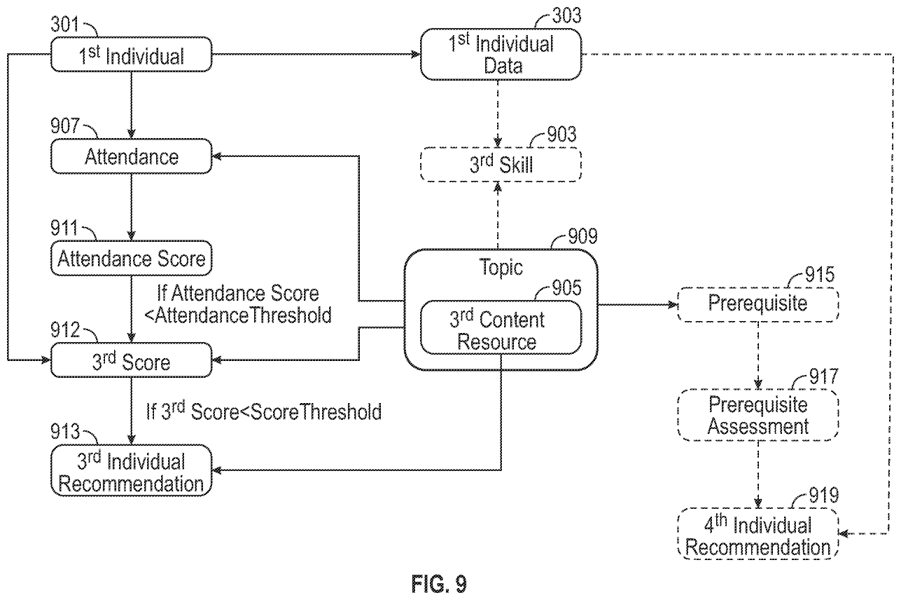

FIG. 9 depicts another example of content recommendation. In one or more embodiments, individuals of the organization can attend topics that constitute training material. For example, an individual can attend a training event, such as a live course in a classroom or a meeting with other individuals in a meeting room, in which topics are taught or discussed. In other scenarios, topics can be taught or discussed in a document that is made available to an individual, such as an online course. Training events or documents may include multiple topics and an individual is allowed to attend one or more of those topics. In FIG. 9, the first individual (301) is requested to attend a topic (909), that includes a third content resource (905), and receives an attendance score (911) based on their attendance (907) to the topic (909). If the attendance score (911) is below a defined attendance threshold, the first individual (301) is considered to have missed the topic (909), and third score (912) is determined, that assesses a proficiency of the first individual (301) at the topic (909), In one or more embodiments, the topic is mapped to a third skill (903), which is also, synchronously, a skill extracted from the first individual data (303), meaning that the third skill (903) is significant for the first individual (301)'s activities. In this case, the third score is determined, based on one or more metrics associated with the third skill (903). In one or more embodiments, the topic (909) includes a content resource textual description, the third skill (903) includes a skill textual description, and the mapping between the topic (909) and the third skill (903) is made by computing a text similarity between the content resource textual description and the skill textual description. If the text similarity between the content resource textual description and the skill textual description is higher than a certain threshold, the topic (909) is mapped to the third skill (903). In one or more embodiments, the third score (912) is computed using information from the first individual data (303), and the computation may involve the use of AI. For instance, an AI algorithm such as an NLP algorithm can be devised to scrape textual information from the first individual data (303) that proves or disproves the proficiency of the first individual (301) at the topic (909). In other embodiments, the NLP algorithm may discover an actual grade at a test assessing the topic (909). If computing the third score (912) is not possible directly from the first individual data (303) or if the topic (909) cannot be mapped to a skill extracted for the first individual (301), the first individual (301) may be requested to take a first assessment test for the topic (909) and the third score (912) is defined as the resulting score at the first assessment test. If the third score (912) is below a certain score threshold, the third content resource (905) is recommended to the first individual as the third individual recommendation (913). In one or more embodiments, the topic (909) is given in a live training event in a classroom, and the attendance score (911) measures the ratio of the time during which the individual attended the topic (909) and the duration of the topic (909), and consequently, the attendance score (911) is set to 0 if the first individual (301) does not attend the topic (909). In one or more embodiments, the topic (909) is assigned a prerequisite (915), and a prerequisite assessment (917) is made for the first individual (301), before the first individual (301) attends the topic (909). The prerequisite assessment (917) determines whether the individual (301) has passed or failed the prerequisite (915). In a similar fashion to how the third score (912) is obtained for the first individual (301) at the topic (909), the prerequisite assessment may be extracted directly from the first individual data (303), for example using AI, or the first individual (301) may be requested to take a second assessment test. In case the prerequisite assessment (917) is failed, the prerequisite (915) is recommended to the first individual (301) as a fourth individual recommendation (919). In one or more embodiments, the prerequisite assessment is done using AI.

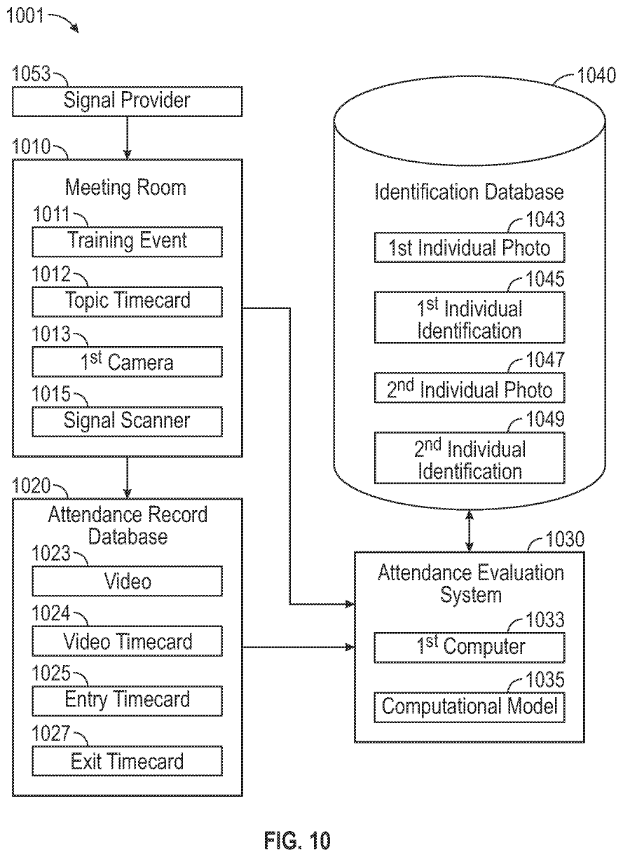

In one or more embodiments, the topic (909) is part of a training event (1011) occurring in a meeting room (1010) and the attendance score (911) is determined automatically, using an attendance monitoring system (1001), described in FIG. 10. Components of the attendance monitoring system (1001) include the meeting room (1010), an attendance record database (1020), an attendance evaluation system (1030) and an identification database (1040).

In one or more embodiments, the attendance monitoring system (1001) includes a first camera (1013), that films the training event (1011) for some topics, including the topic (909), and records a digital video (1023) with a constant frame rate that is stored in the attendance record database (1020). A video timecard (1024), including a start time of the video (1023) and an end time of the video (1023), is also stored in the attendance record database (1020). The training event (1011) includes a topic timecard (1012), that contains a first temporal set, composed of the union of time intervals during which the topic (909) is covered at the training event (1011). For each frame of the video (1023), an attendance status of the first individual (301) is determined for that frame by using a computational model (1035), hosted and run on a first computer (1033). In one or more embodiments, the attendance status for a frame is a binary indicator equal to “positive” if the first individual (301) appears on that frame, meaning that the first individual is attending the topic (909) when the frame is recorded, and “negative” if the first individual (301) does not appear on that frame, meaning that the first individual is not attending the topic (909) when the frame is recorded. The video (1023) has a total number of frames, n, and the frames of the video (1023) are sorted in the order in which they are recorded, so that each frame is assigned an ordinal number, i, for i ranging from 1 to n, corresponding to its ordinal position in the sorting. The first frame occurs at the start time of the video (1023) and the last frame occurs at the end time of the video (1023) according to the video timecard (1024). Accordingly, the time at which an i^{th} frame is recorded is equal to the start time of the video (1023) according to the video timecard (1024), increased by the frame rate times (i−1)/n. It follows that a second temporal set is determined, composed of the union of time intervals during which the first individual (301) appears in the video (1023). A third temporal set, defined as the intersection of the first temporal set and the second temporal set, represents a union of time intervals during which the first individual (301) attends the topic (909). In one or more embodiments, the attendance score (911) of the first individual (301) for the topic (909) is based on the percentage of time during which the first individual (301) appears on the video (1023) at the same time as the topic (909) is being covered, which is then computed by dividing the length of the third temporal by the length of the first temporal set. In one or more embodiments, the computational model (1035) includes a face recognition algorithm, which may use AI, that determines an attendance status for the first individual (301) for each frame. Examples of face recognition algorithms are performed in three steps. First, an identification database (1040) is created, containing a photo and identification for each individual in the organization. As such, a first individual photo (1043) and a first individual identification (1045) are recorded in the identification database (1040) for the first individual (301). Examples of information that may be included in the first individual identification (1045) include a name or an identification number for the first individual (301). Similarly, for a second individual (321), a second individual photo (1047) and a second individual identification (1049) are recorded in the identification database (1040). Then, given a frame of a video, a face detection algorithm, such as a Haar cascade algorithm, or a YOLO algorithm, detects whether a face is present in the frame, and in case a face is present in the frame, defines a region in the frame where the face is located. Finally, if a face is detected by the face detection algorithm, a face recognition algorithm identifies which individual corresponds to the detected face by matching the part of the frame within the region where the face is, with a photo from the identification database (1040). Examples of face recognition algorithms that may be used for the face recognition phase include classification models, such as K-nearest neighbors or convolutional neural networks.

In one or more embodiments, the attendance monitoring system (1001) includes a scanning technique. When the first individual (301) enters the meeting room (1010) through an entrance of the meeting room (1010), the first individual (301) supplies a first signal from a signal provider (1053) to a signal scanner (1015), located at an entrance of the meeting room (1010), and the time at which the first individual (301) enters the meeting room (1010) is recorded on an entry timecard (1025) in the attendance record database (1020). When the first individual (301) exits the meeting room (1010) through an exit of the meeting room (1010), the first individual (301) supplies a second signal from the signal provider (1053) to the signal scanner (1015), located at an exit of the meeting room (1010), and the time at which the first individual (301) exits the meeting room (1010) is recorded on an exit timecard (1027) in the attendance record database (1020). A duration of attendance of the first individual (301) to the training event (1011) is the difference between the time on the exit timecard (1027) and the time on the entry timecard (1025). A fourth temporal set, corresponding to the time during which the first individual (301) is present in the meeting room (1010), is defined as the union of time intervals during which the first individual (301) is present in the meeting room (1010), based on the times in the entry timecard (1025) and the times on the exit timecard (1027). A fifth temporal set, defined as the intersection of the first temporal set and the fourth temporal set, represents the union of time intervals during which the first individual (301) is present in the meeting room (1010) and the topic (909) is simultaneously covered. In one or more embodiments, the attendance score (911) is based on the percentage of time during which the first individual (301) is present in the meeting room (1010) at the same time as the topic (909) is being covered, which is then computed by dividing the length of the fifth temporal set by the length of the first temporal set. Examples of a signal that can be provided by the signal provider (1053) and scanned by the signal scanner (1015) include, but are not limited to a radio frequency identification (RFID), a near field communication (NFC) signal, a quick response (QR) code, or a fingerprint. Examples of the signal provider (1053) include a device in possession of the first individual (301), such as a cell phone or an organization badge, or, in case the signal provided is a fingerprint, a finger of the first individual.

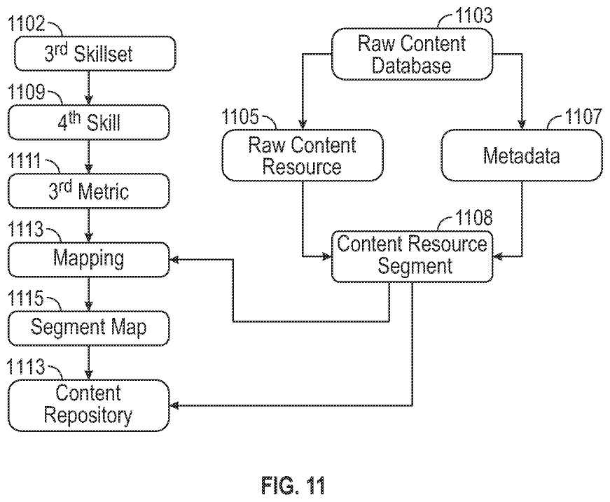

FIG. 11 depicts a method for generating a content repository (113) of content resources in accordance with one or more embodiments. As an initialization step, an empty repository of content resources is created, intended to be filled with content resource and become the content repository (113). A raw content resource (1105) and metadata (1107) for the raw content resource (1105) is obtained from a raw content database (1103). The raw content database (1103) is typically obtained from the organization's activities, that may include an audio or video recordings of learning events, a written presentation, a standards and best practices database, a weekly activity reporting system and a maintenance work orders system. In this disclosure, the raw content resource (1105) is segmented into content resource segments, including at least one content resource segment (1108). In one or more embodiments, the segmentation of the content resource (1105) into at least one content resource segment is done by a content segmentation model. In one or more embodiments, the content segmentation model is based on AI. A third skillset (1102) is obtained from the organization, including at least a fourth skill (1109). A third metric (1111) is associated with the fourth skill (1109), designed to measure the strength of a relationship between the fourth skill (1109) and any individual in the organization. A mapping (1113) process generates a segment map (1115), that associates the content resource segment (1108) with the third metric (1111). The content resource segment (1108) and its associated segment map (1115) are added to the content repository (113). In one or more embodiments, the mapping (1113) process is based on AI.

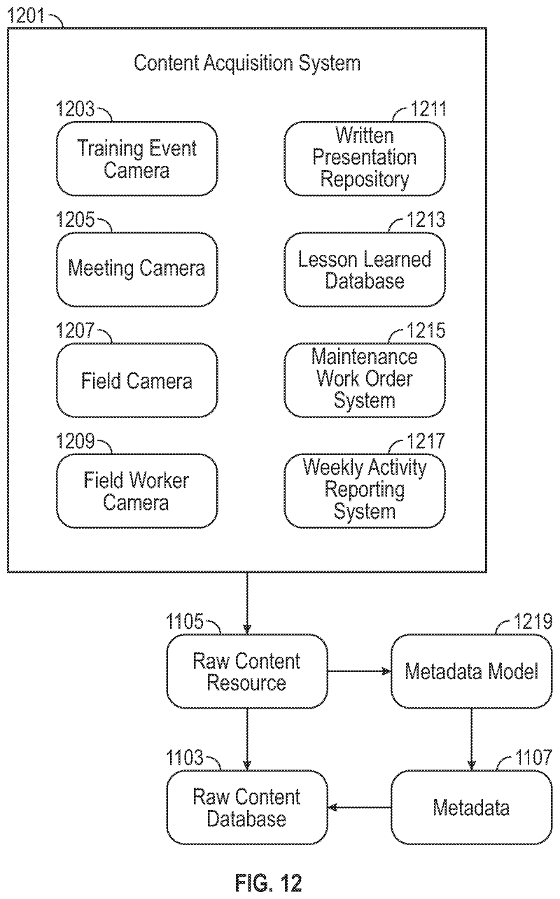

FIG. 12 depicts an example of obtaining the raw content database (1103). In one or more embodiments, the raw content resource (1105) is obtained from a content acquisition system (1201). The content acquisition system (1201) relates to the organizations' operations and can be of various forms. Examples of components of the content acquisition system (1201) include a training event camera (1203), a meeting camera (1205), a field camera (1207) from a field facility, a field worker camera (1209) possessed by a worker, a written presentation repository (1211), a lesson learned database (1213), a maintenance work order system (1215) and a weekly activity reporting system (1217). It is noted that the list of examples of components of the content acquisition system (1201) included herein are given for illustration purposes and is not exhaustive. Other examples of components of the content acquisition system (1201) are not included here for the sake of brevity. Furthermore, examples of components of the content acquisition system (1201) may depend on each organization's activities. The metadata (1107) is obtained from the raw content resource (1105) by using a metadata model (1219). The metadata is intended to describe some aspects of the raw content resource (1105), such as, for example, an outline, a description of its content, a title, a structure, a format, or a context. The metadata model (1219) creates the metadata (1107) and may include manual processes. For instance, an individual enters some or all of the metadata (1107) manually after analyzing the raw content resource (1105). In other instances, the metadata model (1219) may create the metadata (1107) automatically.

In one or more embodiments, the metadata model (1219) includes AI. Examples of AI models that may be included in the metadata model (1219) are NLP models, image detection models or audio detection models. For example, an NLP model may be used to parse text data coming from a written presentation and encode a list of key words that may be included in the metadata (1107). In cases where the raw content resource (1105) is a video recorded during a training event, a video or audio detection model may detect a video or audio event from the video, corresponding to a milestone in the training event, such as a change of lesson. Finally, the raw content resource (1105) and the metadata (1107) are stored into the raw content database (1103).

In one or more embodiments, the content acquisition system includes the training event camera (1203), that records a live training event, with individuals from the organization attending a lecture, given by an instructor, in a meeting room. The filming of the lecture may be initiated manually, using remote control, connected to the training event camera (1203). Initiating the filming of the training event camera (1203) may also be done automatically. For example, if the instructor displays a presentation on a screen in the meeting room, filming may be initiated by detecting the start of the lecture as a first display of a first topic on the screen. For instance, detecting the first topic on the screen may be done by using AI, such as a convolutional neural network (CNN) set up to perform an image detection task, or an optical character recognition (OCR) model. Some optical character recognition models are set up to send an alert when detecting an event in a video. Another way to capture video recordings automatically is to let the training event camera (1203) run continuously, retrieve a training event start time and end time from a training event information, and create a training event video as the portion of the continuous recording between the start time and end time. The resulting training event video may be used as the raw content resource (1105)

In one or more embodiments, the content acquisition system includes the field camera (1207), installed in a field facility, that continuously captures field activities, including work performed by a field worker, or a field accident. The resulting continuous video recording may be stored in a field facility database and included in the raw content resource (1105).

In one or more embodiments, the content acquisition system includes the field worker camera (1209), installed, for example, on a helmet of a field worker, the field worker camera (1209) hence capturing an operational procedure. The field worker camera (1209) may be started manually by the field worker, to record the procedure, or may run continuously. In one or more embodiments, the field worker camera (1209) is connected to an internet of things (IoT) device that sends the captured video recording to the raw content database (1103) and the metadata model (1219).

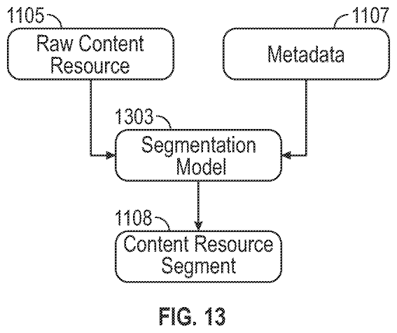

In FIG. 13, the content resource segment (1108) is created from the raw content resource (1105) and the metadata (1107) by using a segmentation model (1303), designed to partition content into smaller segments. For example, the segmentation model (1303) may be designed to divide a long video into smaller videos, or divide a long text into small pieces of text. In one or more embodiments, the raw content resource (1105) is a text, for example a written presentation or a maintenance report, and the segmentation model (1303) splits the text into groups of sentences using AI, each group relating to a similar subject. An example of such an AI model is a combination of a NLP model that detects and encodes each sentence in the text, and a clustering model that clusters the sentences into groups according to the encoding. In one or more embodiments, the raw content resource (1105) is a long video, for example, of a recorded training event with an instructor, and the segmentation model (1303) detects transitions between topics and segments the video into smaller videos, each smaller video covering one topic. As an example, such segmentation can be done manually, where the instructor records the times at which topics start and end. In some embodiments, the instructor is equipped with an electronic device by which the instructor sends start times and end times of the topics to a database, from which the start times and end times of the topic can then be retrieved. The long video is then cut at the recorded times at which topics start and end, resulting in shorter videos, each shorter video covering one topic. By contrast, video segmentation may also be done automatically. In one or more embodiments, the instructor displays presentation slides during the training event, and the segmentation model (1303) is an AI model, that detects topic transition markers on the presentation slides using an optical character recognition (OCR) algorithm. An example of such an AI model includes, at first, obtaining an outline of the training event. Then, a lookup table is generated, that maps transition markers with text descriptions of topics covered in the training event based on the outline. Finally, an OCR algorithm detects the transition markers in the long training event video. When a marker is detected, the OCR algorithm further matches the marker with a corresponding topic, based on the lookup table, and records the marker, the corresponding text description of the topic, and the time at which the marker is detected. The long training event video is then cut at the times where the markers are detected, resulting in shorter videos, each video covering one topic. For each shorter video covering one topic, the text description of the topic is assigned to the video as a video segment textual description.

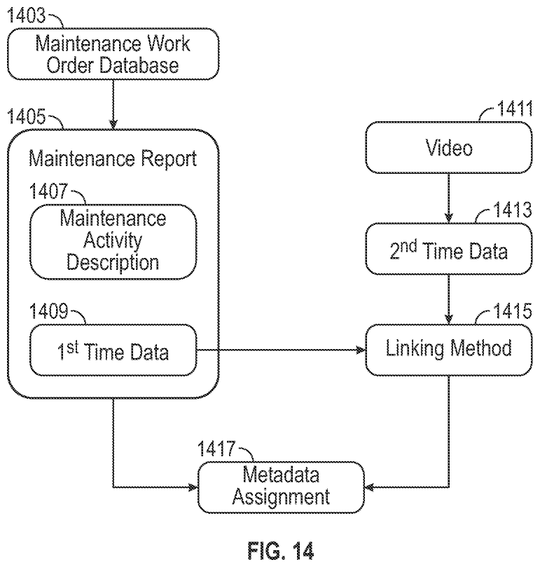

FIG. 14 shows an example of creating the metadata (1107), in accordance with one or more embodiments. In this example, a maintenance report (1405) is extracted from a maintenance work order database (1403), the maintenance report (1405) comprising a maintenance activity description (1407) and a first time data (1409). In this example, the raw content resource (1105) is a video (1411), and a second time data (1413) is associated with the video (1411). Then, based on the first time data (1409) and the second time data (1413), a linking method (1415) determines whether the video records the maintenance activity described in the maintenance activity description (1407). If the linking method (1415) determines that the video records the maintenance activity described in the maintenance activity description (1407), the maintenance report (1405) is assigned into the metadata (1107) for the video (1411), via a metadata assignment (1417).

In one or more embodiments, the first time data (1409) includes a first start date and a first end date of a maintenance activity described in the maintenance activity description (1407), and a first time interval is defined with the first start date as a left boundary and the first end date as a right boundary. In the same way, the second time data (1413) includes a second start date and a second end date of the recording of the video (1411), and a second time interval is defined with the second start date as a left boundary and the second end date as a right boundary. In this case, an example of the linking method (1415) is a computer program that compares the first time interval and the second time interval, and outputs “positive” if the first time interval and the second time interval overlap, or “negative” if the first time interval and the second time interval do not overlap. In case where the output of the linking method is “positive”, the maintenance report (1405) is assigned as a metadata of the video (1411) via a metadata assignment (1417).

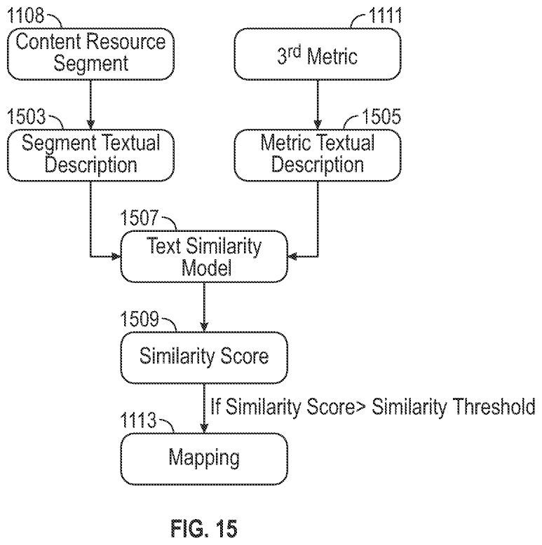

FIG. 15 depicts an example of method for mapping the content resource segment (1108) with the third metric (1111). In this example, a segment textual description (1503) is obtained for the content resource segment (1108) and a metric textual description (1505) is obtained for the third metric (1111). In some embodiments, the content resource segment (1108) is a short video, covering a topic and the segment textual description (1503) is a textual description of the topic. A similarity score (1509) is then obtained from a text similarity model (1507), that measures how much the segment textual description (1503) and the metric textual description (1505) are related. If the similarity score (1509) is higher than a certain similarity threshold, the content resource segment (1108) is mapped with the third metric (1111) as the mapping (1113) process. In one or more embodiments, the text similarity model (1507) makes use of AI, more precisely of a NLP model, that functions by first generating the word embeddings of the segment textual description (1503) and the metric textual description (1505), and then defining the similarity score (1509) based on the distance between these embeddings.

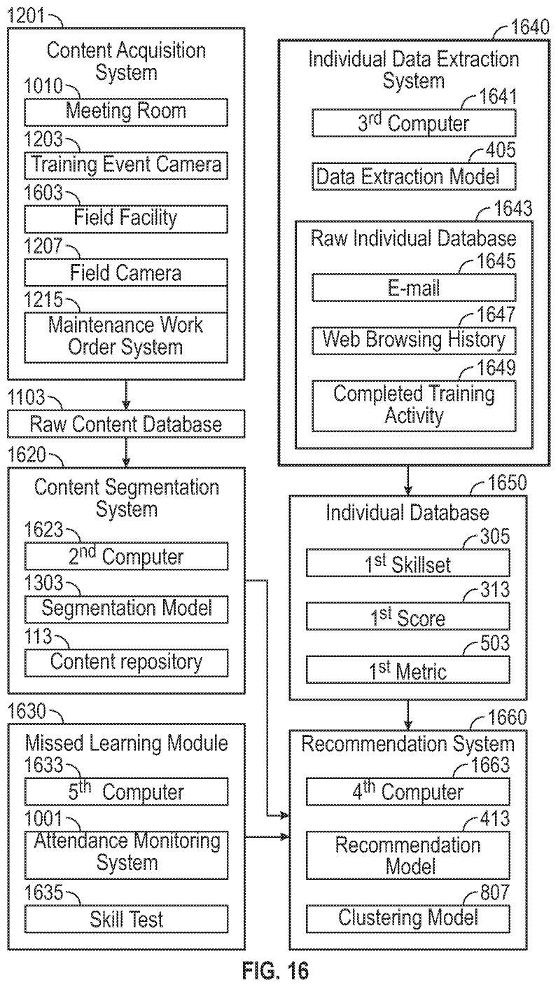

FIG. 16 describes, in accordance with one or more embodiments, a system combining the main elements of this disclosure, for generating a training content repository and then recommending some content resources from this training content repository to individuals within the organization.

It is noted that FIG. 16 describes an example of such a system only. Other systems, or variants of this system may be created, that combine the elements of this disclosure and would still stay in the scope of this disclosure. The system in FIG. 16 contains seven components: a content acquisition system (1201), a raw content database (1103), a content segmentation system (1620), a missed learning module (1630), an individual data extraction system (1640), an individual database (1650) and a recommendation system (1660). For concision, a full description of components and/or elements depicted in FIG. 16 is not provided anew for those components and/elements that have been previously described with reference to the preceding figures. The content acquisition system, as described in FIG. 12 acquires raw content resources, that are then recorded in the raw content database (1103). Examples of raw content acquisition elements are the meeting room (1010), the training event camera (1203), a field facility (1603), in which field operations are performed, the field camera (1207) and the maintenance work order system (1215). Raw content resources from the raw content database (1103) are segmented into content resource segments by the content segmentation system (1620), comprising the segmentation model (1303), a second computer (1623), on which the segmentation model (1303) is hosted and run, and the content repository (113) on which the content resource segments are stored. The individual data extraction system (1640) extracts information about the individuals within the organization, from a raw individual database (1643), including raw individual data such as an e-mail (1645), a web browsing history (1647), or completed training activity (1649). The individual data extraction is performed by the data extraction model (405), hosted and run on a third computer (1641). The extracted individual data is stored into an individual database (1650) that includes skillsets, metrics and scores such as the first skillset (305), the first metric (503), and the first score (309). Individual content resource recommendations are made by the recommendation system (1660), by matching segmented content resources, from the content repository (113), to individual data from the individual database (1650), using the recommendation model (413). The recommendation model (413) is hosted and run on a fourth computer (1663). Collective content resource recommendation is made by propagating individual content resource recommendation from one individual in a group to other individuals in that group, the groups being determined by the clustering model (807) that accesses the individual database (1650). In this example, the clustering model (807) is also hosted and run on the fourth computer (1663). Finally, a missed learning module (1630) includes elements that determine whether an individual has missed a training topic, such as the attendance monitoring system (1001), described in other figures of this disclosure, that returns an attendance score. The attendance monitoring system (1001) is hosted and run on a fifth computer (1633). The missed learning module (1630) further includes a skill test (1635) about a topic, that is given to an individual if they have missed that topic, and returns a skill test score, as described in FIG. 9, in order to determine the individual's proficiency at that topic. The recommendation system (1660) receives attendance scores and skill test scores from the missed learning module (1630) and in turn, assigns a content resource included in a topic, to an individual who scores less than an attendance threshold at that topic, and subsequently fails the skill test (1635)

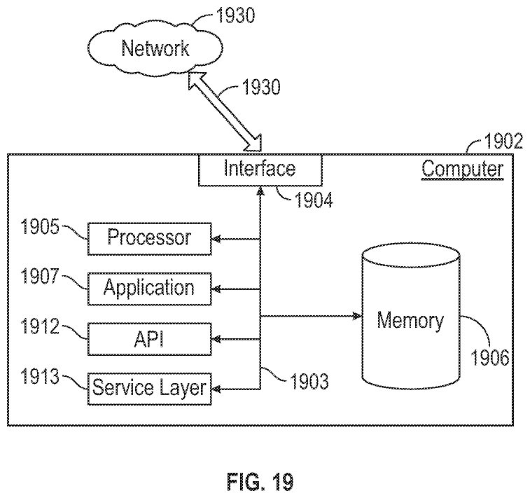

In the example in FIG. 16, as an example only, the different computing actions are associated with different computing systems (“computers”), e.g., a second computer, a third computer, a fourth computer and a fifth computer. It is emphasized that the architecture of the computing components may vary, without departing from the scope of this disclosure. As such, these computers, namely, second computer, third computer, fourth computer and fifth computer, need not be separate entities. Two or more of these computers may be the same computer. An example of a computer is described later in this disclosure in FIG. 19.

FIG. 17 depicts an example of continuously capturing individual data in the organization. In Step (1703), data extraction is initiated for the first individual (301) as soon as the first individual (301) enters the organization. A human or machine reads records related to the first individual (301) from a corporate system in Step (1707) and records the result in the raw individual database (1643). Examples of such records are included in box (1709). Then, content is captured from a first individual (301) personal computer that runs on the organization's network in Step (1711) and stored in the raw individual database (1643). Examples of such records are included in box (1713). Then, in Step (1715), unstructured text data from the raw individual database (1643) is scraped. As a result, structured text data is extracted from unstructured text data in Step (1717). In one or more embodiments, the extraction of structured text data from unstructured text data is done by the data extraction model (405). Finally, in Step (1719), the first individual (301) data captured in Step (1717) is stored in the raw individual database (1643). Finally, Step (1719) connects back to Step (1703), where data extraction is re-initiated for the first individual (301), meaning that the individual data extraction process described in FIG. 17 runs continuously.

While references to models performing some actions may be distinguished in the figures, such as the data extraction model (405) described in FIG. 4, the recommendation model (413) described in FIG. 4, the NLP model (609) in FIG. 6, or the clustering model (807) described in FIG. 8, these models need not be distinct. That is, in practice, two or more models such as the ones described herein, or rather the task(s) of these models, may be performed by a single AI model. Furthermore, one or more of the previously discussed models, such as the data extraction model (405) described in FIG. 4, the recommendation model (413) described in FIG. 4, the NLP model (609) in FIG. 6, or the clustering model (807) described in FIG. 8, may be Artificial intelligence (AI) models or make use of AI. Artificial intelligence, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI) is adopted herein. However, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

In accordance with one or more embodiments, one or more of the previously discussed models, such as the data extraction model (405) described in FIG. 4, the recommendation model (413) described in FIG. 4, the NLP model (609) in FIG. 6, or the clustering model (807) described in FIG. 8, may be, or make use of a neural network (NN), such as a convolutional neural network (CNN) or a recurrent neural network (RNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

A diagram of a neural network is shown in FIG. 18. At a high level, a neural network (1800) may be graphically depicted as being composed of nodes (1802), where here any circle represents a node, and edges (1804), shown here as directed lines. The nodes (1802) may be grouped to form layers (1805). FIG. 18 displays four layers (1808, 1810, 1812, 1814) of nodes (1802) where the nodes (1802) are grouped into columns, however, the grouping need not be as shown in FIG. 18. The edges (1804) connect the nodes (1802). Edges (1804) may connect, or not connect, to any node(s) (1802) regardless of which layer (1805) the node(s) (1802) is in. That is, the nodes (1802) may be sparsely and residually connected. A neural network (1800) will have at least two layers (1805), where the first layer (1808) is considered the “input layer” and the last layer (1814) is the “output layer.” Any intermediate layer (1810, 1812) is usually described as a “hidden layer.” A neural network (1800) may have zero or more hidden layers (1810, 1812) and a neural network (1800) with at least one hidden layer (1810, 1812) may be described as a “deep” neural network or as a “deep learning method.” In general, a neural network (1800) may have more than one node (1802) in the output layer (1814). In this case the neural network (1800) may be referred to as a “multi-target” or “multi-output” network.

Nodes (1802) and edges (1804) carry additional associations. Namely, every edge is associated with a numerical value. The edge numerical values, or even the edges (1804) themselves, are often referred to as “weights” or “parameters.” While training a neural network (1800), numerical values are assigned to each edge (1804). Additionally, every node (1802) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (1802) and edges (1804) and ƒ is a user-defined function. Incoming nodes (1802) are those that, when the neural network (1800) is viewed or depicted as a directed graph (as in FIG. 18), have directed arrows that point to the node (1802) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (1802) in a neural network (1800) may have a different associated activation function. Often, as a shorthand, activation functions are described by the function ƒ by which it is composed. That is, an activation function composed of a linear function ƒ may simply be referred to as a linear activation function without undue ambiguity.

When the neural network (1800) receives an input, the input is propagated through the network according to the activation functions and incoming node (1802) values and edge (1804) values to compute a value for each node (1802). That is, the numerical value for each node (1802) may change for each received input. Occasionally, nodes (1802) are assigned fixed numerical values, such as the value of 1, that are not affected by the input or altered according to edge (1804) values and activation functions. Fixed nodes (1802) are often referred to as “biases” or “bias nodes” (1806), displayed in FIG. 18 with a dashed circle.

In some implementations, the neural network (1800) may contain specialized layers (1805), such as a normalization layer, or additional connection procedures, like concatenation. One skilled in the art will appreciate that these alterations do not exceed the scope of this disclosure.

As noted, the training procedure for the neural network (1800) comprises assigning values to the edges (1804). To begin training, the edges (1804) are assigned initial values. These values may be assigned randomly, assigned according to a prescribed distribution, assigned manually, or by some other assignment mechanism. Once edge (1804) values have been initialized, the neural network (1800) may act as a function, such that it may receive inputs and produce an output. As such, at least one input is propagated through the neural network (1800) to produce an output. Training data is provided to the neural network (1800). Generally, training data consists of pairs of inputs and associated targets. The targets represent the “ground truth,” or the otherwise desired output, upon processing the inputs. In the context of the instant disclosure, the shape of the inputs and outputs of any neural network depends on which problem the neural network is configured to solve. For instance, in case the data extraction model (405) is a NLP model, an input data may be an unstructured text containing personal data for an individual, while an output data may be a list of words, each word representing a skill, such that each word belongs to both the input data and a predefined list of skills. During training, the neural network (1800) processes at least one input from the training data and produces at least one output. Each neural network (1800) output is compared to its associated input data target. The comparison of the neural network (1800) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (1800) output and the associated target. The loss function may also be constructed to impose additional constraints on the values assumed by the edges (1804), for example, by adding a penalty term, which may be physics-based, or a regularization term. Generally, the goal of a training procedure is to alter the edge (1804) values to promote similarity between the neural network (1800) output and associated target over the training data. Thus, the loss function is used to guide changes made to the edge (1804) values, typically through a process called “backpropagation.”

While a full review of the backpropagation process exceeds the scope of this disclosure, a brief summary is provided. Backpropagation consists of computing the gradient of the loss function over the edge (1804) values. The gradient indicates the direction of change in the edge (1804) values that results in the greatest change to the loss function. Because the gradient is local to the current edge (1804) values, the edge (1804) values are typically updated by a “step” in the direction indicated by the gradient. The step size is often referred to as the “learning rate” and need not remain fixed during the training process. Additionally, the step size and direction may be informed by previously seen edge (1804) values or previously computed gradients. Such methods for determining the step direction are usually referred to as “momentum” based methods.

Once the edge (1804) values have been updated, or altered from their initial values, through a backpropagation step, the neural network (1800) will likely produce different outputs. Thus, the procedure of propagating at least one input through the neural network (1800), comparing the neural network (1800) output with the associated target with a loss function, computing the gradient of the loss function with respect to the edge (1804) values, and updating the edge (1804) values with a step guided by the gradient, is repeated until a termination criterion is reached. Common termination criteria are: reaching a fixed number of edge (1804) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (1804) values are no longer intended to be altered, the neural network (1800) is said to be “trained.”

A structural grouping, or group, of weights is herein referred to as a “filter.” The number of weights in a filter is typically much less than the number of inputs. In a CNN, the filters can be thought of as “sliding” over, or convolving with, the inputs to form an intermediate output or intermediate representation of the inputs which still possesses a structural relationship. Like the neural network (1800), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (1800) to produce a final output. Note that in this context, the neural network (1800) is still considered part of the CNN. Like a neural network (1800), a CNN is trained, after initialization of the filter weights, and the edge (1804) values of the internal neural network (1800), if present, with the backpropagation process in accordance with a loss function.

FIG. 19 depicts a block diagram of a computer (1902) used to provide computational functionalities associated with described algorithms, methods, functions, processes, flows, and procedures as described in this disclosure, according to one or more embodiments. The illustrated computer (1902) is intended to encompass any computing device such as a server, desktop computer, laptop/notebook computer, wireless data port, smart phone, personal digital assistant (PDA), tablet computing device, one or more processors within these devices, or any other suitable processing device, including both physical or virtual instances (or both) of the computing device. Additionally, the computer (1902) may include a computer that includes an input device, such as a keypad, keyboard, touch screen, or other device that can accept user information, and an output device that conveys information associated with the operation of the computer (1902), including digital data, visual, or audio information (or a combination of information), or a GUI.

The computer (1902) can serve in a role as a client, network component, a server, a database or other persistency, or any other component (or a combination of roles) of a computer system for performing the subject matter described in the instant disclosure. In some implementations, one or more components of the computer (1902) may be configured to operate within environments, including cloud-computing-based, local, global, or other environment (or a combination of environments).

At a high level, the computer (1902) is an electronic computing device operable to receive, transmit, process, store, or manage data and information associated with the described subject matter. According to some implementations, the computer (1902) may also include or be communicably coupled with an application server, e-mail server, web server, caching server, streaming data server, business intelligence (BI) server, or other server (or a combination of servers).

The computer (1902) can receive requests over network (1930) from a client application (for example, executing on another computer (1902)) and responding to the received requests by processing the said requests in an appropriate software application. In addition, requests may also be sent to the computer (1902) from internal users (for example, from a command console or by other appropriate access method), external or third-parties, other automated applications, as well as any other appropriate entities, individuals, systems, or computers.

Each of the components of the computer (1902) can communicate using a system bus (1903). In some implementations, any or all of the components of the computer (1902), both hardware or software (or a combination of hardware and software) may interface with each other or the interface (1904) (or a combination of both) over the system bus (1903) using an application programming interface (API) (1912) or a service layer (1913) (or a combination of the API (1912) and service layer (1913). The API (1912) may include specifications for routines, data structures, and object classes. The API (1912) may be either computer-language independent or dependent and refer to a complete interface, a single function, or even a set of APIs. The service layer (1913) provides software services to the computer (1902) or other components (whether or not illustrated) that are communicably coupled to the computer (1902). The functionality of the computer (1902) may be accessible for all service consumers using this service layer. Software services, such as those provided by the service layer (1913), provide reusable, defined business functionalities through a defined interface. For example, the interface may be software written in JAVA, C++, or other suitable language providing data in extensible markup language (XML) format or another suitable format. While illustrated as an integrated component of the computer (1902), alternative implementations may illustrate the API (1912) or the service layer (1913) as stand-alone components in relation to other components of the computer (1902) or other components (whether or not illustrated) that are communicably coupled to the computer (1902). Moreover, any or all parts of the API (1912) or the service layer (1913) may be implemented as child or sub-modules of another software module, enterprise application, or hardware module without departing from the scope of this disclosure.

The computer (1902) includes an interface (1904). Although illustrated as a single interface (1904) in FIG. 19, two or more interfaces (1904) may be used according to particular needs, desires, or particular implementations of the computer (1902). The interface (1904) is used by the computer (1902) for communicating with other systems in a distributed environment that are connected to the network (1930). Generally, the interface (1904) includes logic encoded in software or hardware (or a combination of software and hardware) and operable to communicate with the network (1930). More specifically, the interface (1904) may include software supporting one or more communication protocols associated with communications such that the network (1930) or interface's hardware is operable to communicate physical signals within and outside of the illustrated computer (1902).

The computer (1902) includes at least one computer processor (1905). Although illustrated as a single computer processor (1905) in FIG. 19, two or more processors may be used according to particular needs, desires, or particular implementations of the computer (1902). Generally, the computer processor (1905) executes instructions and manipulates data to perform the operations of the computer (1902) and any algorithms, methods, functions, processes, flows, and procedures as described in the instant disclosure.

The computer (1902) also includes a memory (1906) that holds data for the computer (1902) or other components (or a combination of both) that can be connected to the network (1930). The memory may be a non-transitory computer readable medium. For example, memory (1906) can be a database storing data consistent with this disclosure. Although illustrated as a single memory (1906) in FIG. 19, two or more memories may be used according to particular needs, desires, or particular implementations of the computer (1902) and the described functionality. While memory (1906) is illustrated as an integral component of the computer (1902), in alternative implementations, memory (1906) can be external to the computer (1902).

The application (1907) is an algorithmic software engine providing functionality according to particular needs, desires, or particular implementations of the computer (1902), particularly with respect to functionality described in this disclosure. For example, application (1907) can serve as one or more components, modules, applications, etc. Further, although illustrated as a single application (1907), the application (1907) may be implemented as multiple applications (1907) on the computer (1902). In addition, although illustrated as integral to the computer (1902), in alternative implementations, the application (1907) can be external to the computer (1902).

There may be any number of computers (1902) associated with, or external to, a computer system containing computer (1902), wherein each computer (1902) communicates over network (1930). Further, the term “client,” “user,” and other appropriate terminology may be used interchangeably as appropriate without departing from the scope of this disclosure. Moreover, this disclosure contemplates that many users may use one computer (1902), or that one user may use multiple computers (1902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a content repository comprising one or more content resources;
obtaining a first individual data for a first individual;
determining, from the first individual data, a first skillset for the first individual, the first skillset comprising a first skill, the first skill comprising a first metric comprising a first description and first value;
determining a first score for the first skill based on the first individual data and the first metric;
obtaining a content map that associates each skill in the first skillset to at least one content resource of the content repository;
recommending a first content resource from the content repository for the first individual based on the first score and the content map.

2. The method of claim 1, wherein the first individual data comprises an application usage of the first individual.

3. The method of claim 1, wherein the first skill further comprises:
a first weight associated with the first metric;
a second metric comprising a second description and a second value; and
a second weight associated with the second metric, and
wherein the first score is a weighted average of the first metric and the second metric based on the first weight and second weight.

4. The method of claim 1, wherein the first skillset further comprises a second skill.

5. The method of claim 1, further comprising:
obtaining a second individual data for a second individual;
determining, from the second individual data, a second skillset for the second individual,
the second skillset comprising a first skill, the first skill comprising a first metric,
the first metric comprising a first description and first value;
determining a first score for the first skill of the second skillset based on the second individual data and the first metric of the first skill of the second skillset;
determining a similarity metric between the first skillset and the second skillset; and
recommending a second content resource from the content repository for the first individual based on the similarity metric.

6. The method of claim 1, wherein the first value is determined by a first artificial intelligence (AI) model.

7. The method of claim 6,
wherein the first description is a first textual description comprising at least one word, and
wherein the first individual data comprises text data comprising at least one word.

8. The method of claim 7, wherein the first AI model comprises a natural language processing model and the first value is determined through a comparison of the first textual description and the text data.

9. The method of claim 5, wherein determining the similarity metric is performed by a second artificial intelligence (AI) model.

10. The method of claim 9, wherein the second AI model is a clustering model.

11. The method of claim 1, further comprising:
determining an attendance of the first individual for a topic comprising a third content resource;
determining a third skill within the first skillset that corresponds to the topic;
obtaining an attendance threshold;
comparing the attendance to the attendance threshold;
when the attendance is less than the attendance threshold:
obtaining a score threshold;
obtaining a third score, the third score computed from one or more metrics of the third skill; and
when the third score is less than the score threshold:
recommending the third content resource to the first individual.

12. A method for generating a content repository of content resources, comprising:
obtaining a set of skills, each skill in the set of skills comprising at least one metric;
obtaining a content resource;
obtaining metadata for the content resource;
segmenting the content resource into one or more segments based on the metadata;
mapping each segment to at least one metric comprised by the set of skills; and
updating the content repository of content resources with the segmented content resource and associated mapping.

13. The method of claim 12, wherein the content resource is a video acquired using a camera.

14. The method of claim 13, wherein the metadata is an outline of information presented in the video.

15. The method of claim 13,
wherein the metadata is a maintenance report comprising a first time data and an activity description of a maintenance activity, the maintenance report acquired from a maintenance work order database, and
wherein the maintenance report is assigned to the metadata of the video by a linking method, the linking method comprising:
obtaining second time data for the video; and
determining that the video records the maintenance activity based on, at least, the first time data and the second time data.

16. The method of claim 12, wherein segmenting the content resource into one or more segments based on the metadata is performed by a first artificial intelligence model.

17. The method of claim 12, wherein mapping each segment to at least one metric comprised by the set of skills comprises:
for each segment:
obtaining a segment textual description of the segment comprising at least one word; and
for each metric:
obtaining a metric textual description of the metric comprising at least one word;
determining, with a second artificial intelligence (AI) model, a similarity score between the segment and the metric based on the segment textual description and the metric textual description;
comparing the similarity score to a similarity threshold; and
mapping the segment to the metric if the similarity score is greater than the similarity threshold.

18. A system, comprising:
a first computer configured to:
access a content repository of content resources comprising one or more content resources;
receive a first individual data for a first individual;
determine, from the first individual data, a first skillset for the first individual, the first skillset comprising a first skill, the first skill comprising a first metric comprising a first description and first value;
determine a first score for the first skill based on the first individual data and the first metric;
access a content map that associates each skill in the first skillset to at least one content resource of the content repository of content resources;
recommend a first content resource from the content repository of content resources for the first individual based on the first score and the content map;
receive a second individual data for a second individual;
determine, from the second individual data, a second skillset for the second individual, the second skillset comprising a first skill, the first skill comprising a first metric, the first metric comprising a first description and first value;
determine a second score for the first skill of the second skillset based on the second individual data and the first metric;
determine a similarity metric between the first skillset and the second skillset;
recommend a second content resource from the content repository for the first individual based on the similarity metric.

19. The system of claim 18, wherein the computer is further configured to:
determine an attendance of the first individual for a topic comprising a third content resource;
determine a third skill within the first skillset that corresponds to the topic;
receive an attendance threshold;
make a first determination whether the attendance is less than the attendance threshold; and
based on the first determination that the attendance is less than the attendance threshold:
receive a score threshold;
receive a third score, the third score computed from one or more metrics of the third skill; and
when the third score is less than the score threshold, recommend the third content resource to the first individual.

20. The system of claim 18,
further comprising a content acquisition system, comprising:
a meeting room,
a first camera installed in the meeting room,
a field facility, wherein process data for the field facility is stored in a field facility database,
a second camera installed in the field facility, and
a second computer configured to:
receive an input creating an empty repository of content resources,
receive a content resource from the data acquisition system,
receive, from the data acquisition system, metadata for the content resource,
segment the content resource into one or more segments based on the metadata,
receive a set of skills, each skill in the set of skills comprising at least one metric,
map each segment to at least one metric comprised by the set of skills, and
update the content repository of content resources with the segmented content resource and associated mapping;
wherein mapping each segment to at least one metric comprised by the set of skills, comprises:
for each segment:
obtaining a segment textual description of the segment comprising at least one word; and
for each metric:
obtaining a metric textual description of the metric comprising at least one word;
determining, with an artificial intelligence (AI) model, a similarity score between the segment and the metric based on the segment textual description and the metric textual description;
making a second determination whether the similarity score is greater than a similarity threshold; and
based on the second determination that the similarity score is determined greater than the similarity threshold, mapping the segment to the metric.
